(19) United States
(12) Patent Application Publication
(10) Pub. No.: US 2017/0115168 A1
(43) Pub. Date: Apr. 27, 2017

(54) METHOD OF ESTIMATING A TEMPERATURE OF A PERMANENT MAGNET IN A MOTOR

(71) Applicant: Hyundai Motor Company, Seoul (KR)

(72) Inventors: Kyung Su KIM, Nam-gu (KR); Seong Yeop LIM, Seoul (KR); Jeong Won RHO, Seoul (KR); Seong Min KIM, Changwon-si (KR); Dae Woong HAN, Anyang-si (KR); Gu Bae KANG, Yongin-si (KR)

(73) Assignee: Hyundai Motor Company, Seoul (KR)

(21) Appl. No.: 15/216,354

(22) Filed: Jul. 21, 2016

(30) Foreign Application Priority Data
Oct. 23, 2015 (KR) 10-2015-0147954

(51) Int. Cl. G01K 11/00; G01K 17/00; H02K 21/26

(52) U.S. Cl. CPC G01K 11/00; H02K 21/26; G01K 17/00

(57) ABSTRACT

A method of estimating a temperature of a permanent magnet in a motor that is capable of precisely estimating the temperature of a permanent magnet included in a motor and of preventing demagnetization of the magnet is provided. Specifically, the method of estimating a temperature of a permanent magnet in a motor is capable of deriving heat transfer coefficients through an analysis of an interrelation between a variation of permanent magnet temperature and a rotor loss per motor operating condition based on an actually measured value and constructing a heat model of the permanent magnet using the same to estimate the temperature of the permanent magnet, and accordingly, it is possible to precisely estimate real-time temperature of the permanent magnet based on the operational condition of the motor.

### CROSS-REFERENCE TO RELATED APPLICATION

This application claims the benefit of priority under 35 U.S.C. §119(a) to Korean Patent Application No. 10-2015-0147954, filed on Oct. 23, 2015, the entire contents of which are incorporated herein by reference.

### BACKGROUND

(a) Technical Field

The present disclosure relates to a method of estimating the temperature of a permanent magnet in a motor. More particularly, it relates to a method of estimating the temperature of a permanent magnet in a motor that is capable of precisely estimating the temperature of a permanent magnet included in a motor, thereby preventing demagnetization of the magnet.

(b) Background Art

Excessive heat may be generated from an interior permanent magnet synchronous motor (IPMSM), which is mounted in an environment-friendly vehicle, due to an eddy current loss occurring in the permanent magnet depending on the operating conditions, with the result that the magnet may be demagnetized.

In addition, the demagnetization of the permanent magnet may cause problems, such as the reduction in performance of the motor and the reduction in control performance for protecting withstanding voltage of a power module in an inverter for motor control.

Therefore, it is necessary to provide a method of estimating the temperature of the magnet in real time based on the operating conditions of the motor.

In a conventional permanent magnet estimation method, the temperature of the permanent magnet on the rotor side is estimated using a temperature sensor mounted to a stator coil of the motor.

More specifically, in the conventional permanent magnet estimation method, the temperature sensor mounted to the stator coil of the motor measures the temperature of the stator coil, and the measured temperature of the stator coil is taken as the temperature of the permanent magnet (the temperature of the stator coil=the temperature of the permanent magnet).

The estimated temperature of the permanent magnet is used to construct a current map and, in addition, is used as an Id/Iq current control factor per magnet temperature and as the specification of withstanding voltage of the power module.

However, the conventional permanent magnet estimation method has the following problems.

First, an eddy current loss occurs in the permanent magnet depending on the operational state of the motor. If heat is generated from the permanent magnet due to the eddy current loss, a difference occurs between the temperature of the stator coil measured using the temperature sensor and the temperature of the permanent magnet, as shown in FIG. 1. As a result, it is not possible to precisely measure the temperature of the permanent magnet based on the operational condition of the motor.

Second, the Id/Iq current control factor per magnet temperature may be imprecise due to the difference in temperature between the stator coil and the permanent magnet, with the result that the current control performance of the inverter for motor control is lowered, making it difficult to establish the control specification for protecting the withstanding voltage of the power module.

Third, the temperature of the permanent magnet is not precisely estimated, with the result that the output performance of the motor is lowered due to demagnetization of the permanent magnet.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present disclosure has been made in an effort to address the above-described problems associated with the prior art and it is an object of the present disclosure to provide a method of estimating the temperature of a permanent magnet in a motor that is capable of deriving heat transfer coefficients through the analysis of an interrelation between a variation of permanent magnet temperature and a rotor loss per motor operating condition based on an actually measured value and constructing a heat model of the permanent magnet using the same to estimate the temperature of the permanent magnet. Accordingly, it is possible to precisely estimate real-time temperature of the permanent magnet based on the operational condition of the motor.

In one aspect, the present disclosure provides a method of estimating temperature of a permanent magnet in a motor, the method including substituting motor torque/speed into a rotor ion loss map to acquire a rotor ion loss based on the motor torque/speed and estimating the temperature of the permanent magnet using the acquired rotor ion loss and heat transfer coefficients differently derived based on a change of the motor speed.

In some forms, the rotor ion loss map may be constructed based on efficiency map data per voltage based on the motor torque/speed after actually measuring the rotor ion loss per motor speed/torque.

In another form, at the step of acquiring the rotor ion loss, the motor torque/speed based on driving of the motor may be substituted into the rotor ion loss map in order to acquire the rotor ion loss based on the motor torque/speed through map interpolation per voltage.

In still another form, the heat transfer coefficients may be derived by analyzing an interrelation between an actually measured rotor ion loss and an increase value of the temperature of the permanent magnet.

In yet another form, the temperature of the permanent magnet may be estimated using the following equation: Y=Cₜ(Ax+B), where Y indicates estimated temperature of the permanent magnet, Cₜ indicates time constant, x indicates a rotor ion loss, and A and B indicate heat transfer coefficients (estimated coefficients).

Other aspects and forms of the disclosure are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the disclosure are discussed infra.

### BRIEF DESCRIPTION OF THE DRAWINGS

The above and other features of the present disclosure will now be described in detail with reference to certain exemplary forms thereof illustrated in the accompanying drawings which are given hereinbelow by way of illustration only, and thus are not limitative of the present disclosure, and wherein:

FIG. 1 is a graph showing a difference in temperature between a permanent magnet and a stator coil over time during a load operation of a motor;

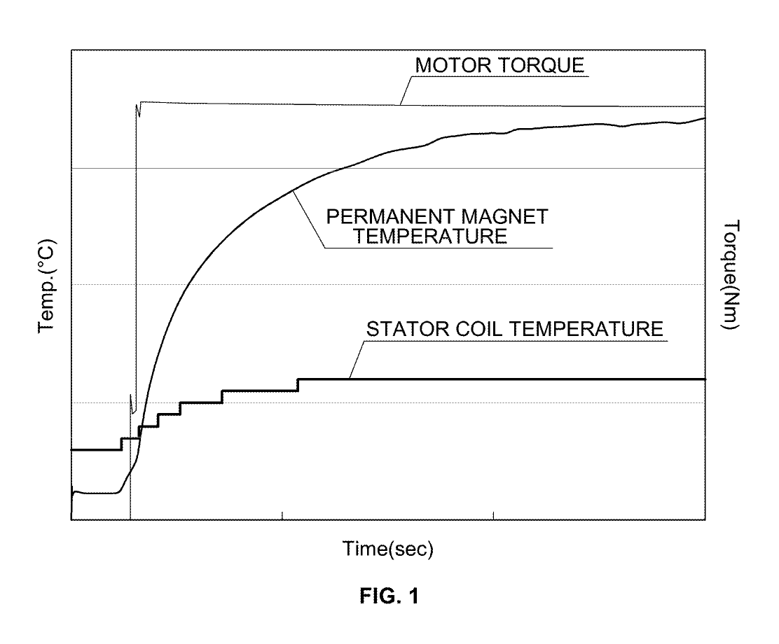

FIG. 2 is a view schematically showing a method of estimating a temperature of a permanent magnet in a motor, especially a process of analyzing an interrelation between a rotor iron loss based on actual measurement and permanent magnet temperature;

FIG. 3 is a control diagram showing a method of estimating the temperature of the permanent magnet in the motor, especially a process of estimating permanent magnet temperature based on the operational condition of the motor;

FIG. 4 is a graph showing a comparison between permanent magnet temperature estimated using a method of estimating the temperature of the permanent magnet and actually measured temperature; and

FIG. 5 is a graph showing a comparison between permanent magnet temperature, estimated using a method of estimating the temperature of the permanent magnet in the motor when the operational condition of the motor is changed, and actually measured temperature.

It should be understood that the appended drawings are not necessarily to scale, presenting a somewhat simplified representation of various preferred features illustrative of the basic principles of the invention. The specific design features of the present disclosure as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various forms of the present disclosure, examples of which are illustrated in the accompanying drawings and described below. While the disclosure will be described in conjunction with exemplary forms, it will be understood that present description is not intended to limit the invention to those exemplary forms. On the contrary, the disclosure is intended to cover not only the exemplary forms, but also various alternatives, modifications, equivalents and other forms, which may be included within the spirit and scope of the disclosure as defined by the appended claims.

As previously described, a current map reference error and high-temperature demagnetization of a permanent magnet may occur due to the deviation in temperature between a stator coil and the permanent magnet based on the operational condition of a motor.

The difference in temperature between the stator coil and the permanent magnet is caused by a lost heat due to an eddy current loss, which is part of a rotor ion loss in the load operating condition of the motor, rather than convection heat due to heat generated by the stator coil. Therefore, the present disclosure is characterized by constructing a heat model that is capable of estimating a heat loss attributable to an eddy current loss in real time.

In other words, the present disclosure is characterized by providing a method of estimating the temperature of a permanent magnet in a motor that is capable of constructing a rotor ion map based on efficiency map data per voltage based on torque/speed per voltage applied to the motor, deriving a magnet temperature estimation equation through the analysis of an interrelation between a variation of permanent magnet temperature and a rotor loss per motor operating condition based on an actually measured value, and estimating the temperature of the permanent magnet based on the operational condition of the motor in real time using the derived magnet temperature estimation equation.

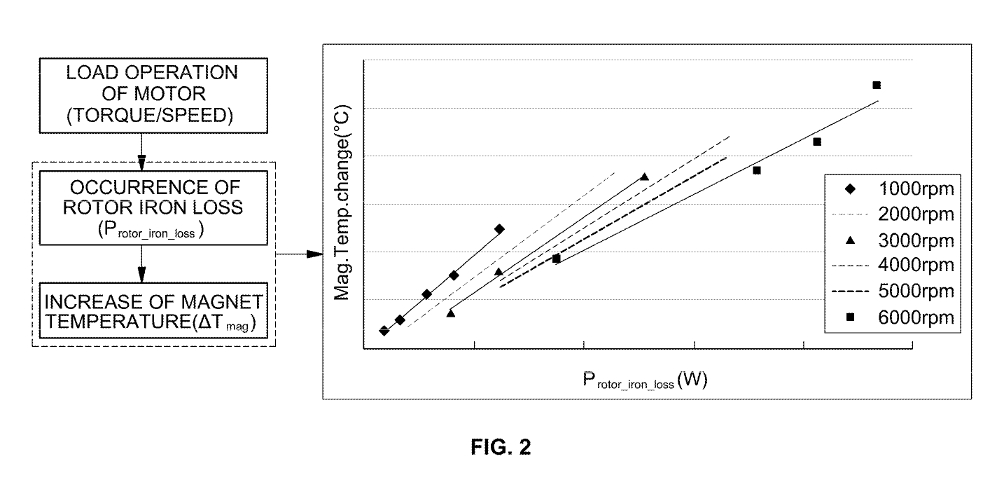

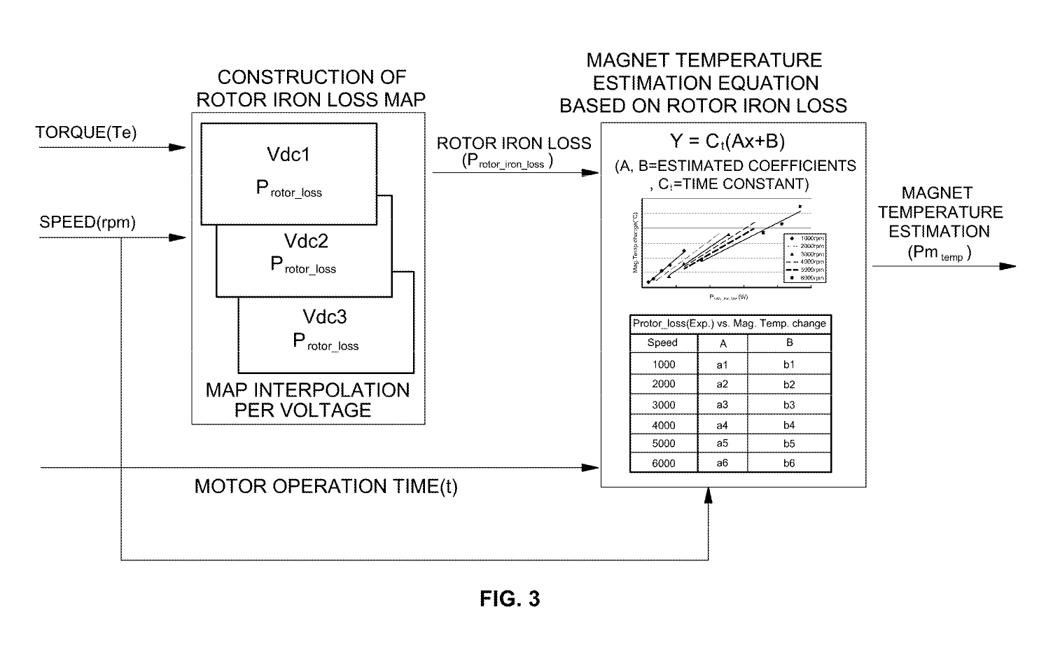

FIG. 2 is a view schematically showing a method of estimating the temperature of a permanent magnet in a motor, especially a process of analyzing an interrelation between a rotor iron loss based on actual measurement and permanent magnet temperature, and FIG. 3 is a control diagram showing the method of estimating the temperature of the permanent magnet in the motor, especially a process of estimating permanent magnet temperature based on the operational condition of the motor.

In the method of estimating the temperature of the permanent magnet in the motor, a rotor ion loss Pᵣₒₜₒᵣ_{_}ᵢᵣₒₙ_{_}ₗₒₛₛ per motor speed/torque based on the load operation of the motor is actually measured first.

Subsequently, a rotor ion loss map is constructed for datafication of the actually measured rotor ion loss per motor speed/torque.

The rotor ion loss map may be constructed based on efficiency map data per voltage based on motor torque/speed after actually measuring the rotor ion loss per motor speed/torque.

Consequently, the rotor ion loss per motor speed/torque is actually measured to construct a rotor ion loss map per voltage based on motor torque/speed.

In addition, an interrelation between the actually measured rotor ion loss Pᵣₒₜₒᵣ_{_}ᵢₒₙ_{_}ₗₒₛₛ and an increase value ΔTmag of the permanent magnet temperature is analyzed to derive heat transfer coefficients of the permanent magnet.

As can be seen from the graph of FIG. 2, the actually measured rotor ion loss Pᵣₒₜₒᵣ_{_}ᵢₒₙ_{_}ₗₒₛₛ is changed as the motor speed is changed, and the increase value ΔTmag of the permanent magnet temperature is changed as the actually measured rotor ion loss is changed. Consequently, it is possible to derive the heat transfer coefficients of the permanent magnet based on the change in the motor speed.

As can be seen from the table of FIG. 3, the heat transfer coefficients of the permanent magnet, which are estimated coefficients, are differently derived based on the change in the motor speed. A magnet temperature estimation equation based on the rotor ion loss using the derived heat transfer coefficients may be defined by Equation 1 below.

Y=Cₜ(Ax+B) Equation 1

Where Y indicates estimated temperature of the permanent magnet, Cₜ indicates time constant, x indicates a rotor ion loss, and A and B indicate heat transfer coefficients (estimated coefficients).

Hereinafter, a method of estimating the temperature of the permanent magnet in the motor will be described in detail with reference to FIG. 3.

First, motor torque (Te)/speed (rpm) based on driving of the motor is substituted into the rotor ion loss map in order to acquire the rotor ion loss based on the motor torque/speed through map interpolation per voltage.

Subsequently, the acquired rotor ion loss Pᵣₒₜₒᵣ_{_}ᵢᵣₒₙ_{_}ₗₒₛₛ and the motor speed are input to a permanent magnet estimation calculation unit.

The permanent magnet estimation calculation unit estimates the permanent magnet temperature using the rotor ion loss and the heat transfer coefficients differently derived based on the change of the motor speed.

That is, the rotor ion loss x, the heat transfer coefficients A and B based on the change of the motor speed, and the time constant Cₜ, which is a motor operation time, are substituted into Equation 1, Y=Cₜ(Ax+B), in order to acquire a permanent magnet temperature Y (Y=Pmₜₑₘₚ=Mag_Temp(Est)).

The acquired permanent magnet temperature may be estimated in real time based on the real-time operational condition of the motor, and may be used to protect withstanding voltage of a power module in an inverter and to prevent demagnetization of the permanent magnet.

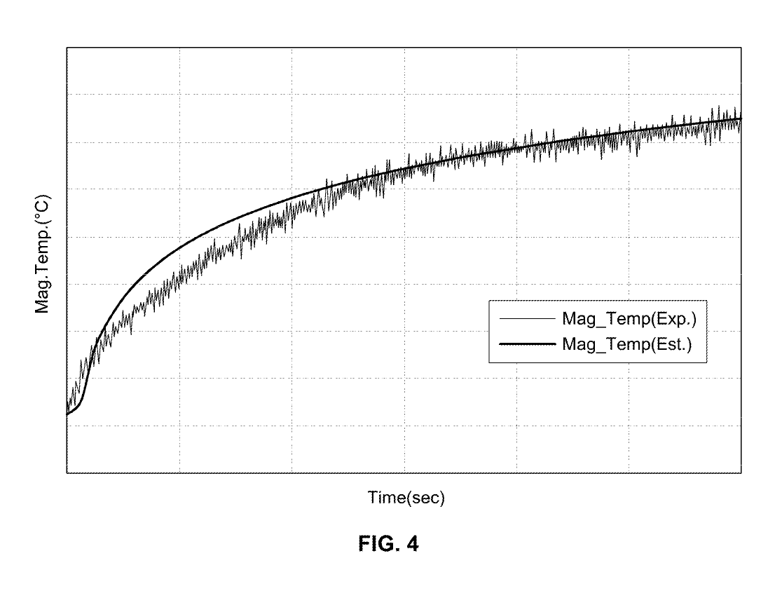

The acquired permanent magnet temperature is compared with an actually measured value (the temperature of the permanent magnet measured through actual experimentation) over time at the same operation point of the motor. The results are shown in FIG. 4.

As can be seen from FIG. 4, the actually measured value Mag_Temp(Exp) of the permanent magnet temperature is changed along a saturation curve due to heat generation caused by the rotor loss over time, and the actually measured value Mag_Temp(Exp) is very similar to the estimated value Mag_Temp(Est) of the permanent magnet temperature.

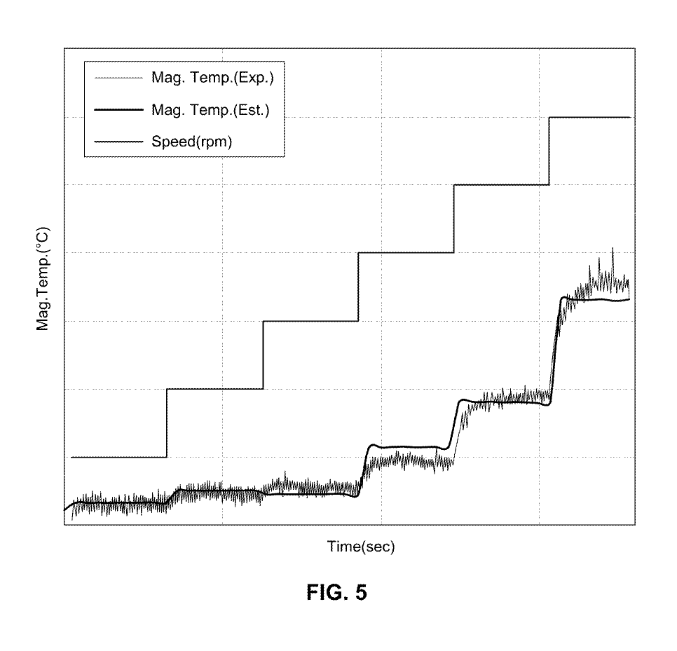

In addition, the acquired permanent magnet temperature is compared with an actually measured value of the permanent magnet temperature based on the change of the real-time operation condition of the motor. The results are shown in FIG. 5.

As can be seen from FIG. 5, the estimated value Mag_Temp(Est) of the permanent magnet temperature based on the change of rotor loss per real-time operation condition of the motor using the heat model is similar to the actually measured value Mag_Temp(Exp) of the permanent magnet temperature, and it is possible to precisely estimate the permanent magnet temperature even when the operational condition of the motor is changed in real time.

As is apparent from the above description, the present disclosure has the following effects.

First, it is possible to precisely estimate the real-time temperature of the permanent magnet based on the operational condition of the motor by constructing a heat model of the permanent magnet.

Second, it is possible to prevent demagnetization of the permanent magnet by improving the precision in estimation of the real-time temperature of the permanent magnet.

Third, it is possible to improve the protection performance of withstanding voltage of the power module in the inverter through strengthening of an arbitrary over-temperature protection logic and to improve motor control performance by improving the precision in estimation of the temperature of the permanent magnet.

The disclosure has been described in detail with reference to forms thereof. However, it will be appreciated by those skilled in the art that changes may be made in these forms without departing from the principles and spirit of the disclosure, the scope of which is defined in the appended claims and their equivalents.

What is claimed is:

1. A method of estimating temperature of a permanent magnet in a motor, the method comprising:
substituting motor torque/speed into a rotor ion loss map to acquire a rotor ion loss based on the motor torque/speed; and
estimating the temperature of the permanent magnet using the acquired rotor ion loss and heat transfer coefficients differently derived based on a change of the motor speed.

2. The method of claim 1, wherein the rotor ion loss map is constructed based on efficiency map data per voltage based on the motor torque/speed after actually measuring the rotor ion loss per motor speed/torque.

3. The method of claim 1, wherein, in the acquiring of the rotor ion loss, the motor torque/speed based on driving of the motor is substituted into the rotor ion loss map in order to acquire the rotor ion loss based on the motor torque/speed through map interpolation per voltage.

4. The method of claim 1, wherein the heat transfer coefficients are derived by analyzing an interrelation between an actually measured rotor ion loss and an increase value of the temperature of the permanent magnet.

5. The method of claim 1, wherein the temperature of the permanent magnet is estimated using the following equation.
Y=Cₜ(Ax+B)
Where Y indicates estimated temperature of the permanent magnet, Cₜ indicates time constant, x indicates a rotor ion loss, and A and B indicate heat transfer coefficients (estimated coefficients).
